(19) United States
(12) Patent Application Publication
(10) Pub. No.: US 2011/0151971 A1
(43) Pub. Date: Jun. 23, 2011

(54) TECHNOLOGICAL PLATFORM FOR GAMING

(76) Inventors: Yaniv Altshuler, Ramat Isna (IL); Adi Ashkenazy, Nes Ziona (IL); Iddit Shalem, Zichron Yaakov (IL); Raviv Nagel, Haifa (IL); Yair Shapira, Haifa (IL); Oren Cohen, Tel Aviv (IL)

(21) Appl. No.: 12/922,175

(22) PCT Filed: Mar. 9, 2009
(86) PCT No.: PCT/IL09/00260

§ 371 Date: Mar. 14, 2011

Related U.S. Application Data
(60) Provisional application No. 61/136,064, filed on Aug. 11, 2008.

(30) Foreign Application Priority Data
Mar. 11, 2008 (IL) 190111

(51) Int. Cl. A63F 9/24

(52) U.S. Cl. 463/30

(57) ABSTRACT

A technological platform in which “clips” or short segments of play from a game may be automatically extracted and optionally analyzed, for example to support later searching of such clips for a clip having one or more features of interest.

### FIELD OF THE INVENTION

The present invention relates to a technological platform for gaming and in particular, for a system and method for supporting such a technological platform.

### BACKGROUND OF THE INVENTION

Modern games consume many processing and storage resources, mainly since the games usually involve progressive 3D (three dimensions) computer graphics and sound effects. A game exists in a computerized world, which comprises various graphical objects. Every object is attributed to a game element, i.e., background, articles, characters etc. Each object is accompanied by a corresponding logic, which defines the operations the object can perform and the rules of actions upon the occurrence of any event.

A simplified example of a game world in car racing game is as follows: The game world comprises objects, such as racetrack, racing cars, sky, observers, etc. The racetrack, the sky and the observers are used as background elements, where the logic of the sky objects can be defined to change according to the weather; the observers can be defined to applaud whenever a specific car is passing, and so on. One car is controlled by the game player and the rest of the cars are automatically controlled by the computer. The logic of the player's car defines the movement options (left, right, accelerate, decelerate) and the rules of actions upon events. For example, a collision between the player's car and another object causes the graphical representation of the car to change, and will also typically induce some other change in the game experience, for example by altering the performance of the car and/or loss of credits in the game. Exceeding the racetrack boundaries will slow down the car, and so on. Some of the computer controlled cars are defined to drive at a certain speed, and some are defined to follow the player's car. Objects can also be defined to perform no action.

Creating a 3D Image of a Game

Every graphical object in the game world has physical 3D dimensions, texture and opacity/transparency, and is located and/or moved in the game space. A 3D computer graphics video can be considered as a movie production. Like in a filming location, the game objects always exist in the game space, even if the objects are not shown all the time. After all the objects are located in the game space, in order to get video images, a camera is located in a certain point. The camera can be located at any point in the game space at any angle, and can move in any direction and at any desired speed. The camera will project the images (on the computer's screen) according to graphical definitions and the locations of the objects in the game space.

During the game operation, many different types of graphical manipulations can be performed. For instance, at a certain camera positioning, if an object is moved, some objects will be revealed and some will be hidden. When playing the game, the player gets rendered images, which means that the images contain only the shown data. Rendered images have no objects. A rendered image is one object composed of pixels, the same as for any other computer image. Capturing the streaming of rendered images of a game and editing the rendered video can currently be done using only video capturing and editing tools. The output of such tools is a video file with a trade-off between the quality of the captured video as compared to the original video stream, versus the size of the file. Video capture that occurs while a player is playing a game can deteriorate the game streaming, since the real-time capturing operation consumes many computer resources for processing and data storage. One option is to capture the whole playing process, which can take hours, and then search the captured video for interesting and meaningful scenes. The editing process of captured video also takes time and requires skills of video editing. The editing possibilities of rendered streaming video are very poor comparing to the editing possibilities of data that is later used to render the video.

Despite the complexity of the present methods for capturing and editing streaming games, these procedures are very popular among players of games. Players publish their game playing moves in order to boast and/or to help others solving situations of game playing, known as “walkthrough”. The publication of the video files is done using video hosting websites (e.g., youtube.com). These websites limit the size, and sometimes the type, of files that may be uploaded, which compels the user to reduce the video quality. Another method of publishing playing moves is using written instructions. There are forums of games where players can publish their instructions for solving situations in playing of games and other can ask questions about such issues. These forums contain a huge list of records, which makes it difficult to find the desired record. The search process usually ends with many records, not all relevant. These records are usually well understood for their publishers, but it is very difficult for others to understand them. There is no efficient tool for investigating a player's moves and way of playing.

Recently, multiplayer games, which are played over the data network (online games), have become very popular. There are games in which each player plays against the rest of the players, and there are games in which players can form a team and play as a team against other teams or against other individual players. These kinds of games can last for any length of time, for example from a few seconds to months or even years. These games comprise huge game worlds, which are populated by many players simultaneously, and exist in a dedicated server. Many online games have associated online communities, making online games a kind of social activity.

The server of an online game comprises the game world and the engine. Each player uses his own computer, on which a dedicated application is optionally installed. The application optionally only handles the local game, which means that it receives the game objects from the server of the game and renders it for the local game output (e.g. display, audio, etc.). The application sends the actions of the player (e.g. pressed keys of the keyboard, mouse clicks, joystick operations, voice commands, voice chat etc.) to the server to be translated at the server for performing game actions. Alternatively, the application also handles more, if not all, of the game actions.

### SUMMARY OF THE INVENTION

The background art does not teach or suggest a technological platform for gaming which enables the actions of a player to be analyzed. The background art also does not teach or suggest such a platform in which “clips” or short segments of play from a game may be automatically extracted. The background art also does not teach or suggest such a platform in which such “clips” are analyzed, for example in order to be able to search through a plurality of such clips for one or more clips having desired characteristics.

The present invention overcomes these drawbacks of the background art by providing a technological platform in which “clips” or short segments of play from a game may be automatically extracted. The short segments of play may optionally be extracted automatically according to one or more predefined criteria. Alternatively, the short segments of play may optionally be extracted from saved game playing data, such that optionally and more preferably, the extraction process may be performed according to one or more criteria that are set after game play has occurred.

By “game” or “gaming” it is optionally meant any type of game in which at least a portion of the game play and/or at least one game action occurs electronically, through a computer or any type of game playing device, as described in greater detail below. Such games include but are not limited to portable device games, computer games, on-line games, multi-player on-line games, persistent on-line or other computer games, games featuring short matches, single player games, automatic player games or games featuring at least one “bot” as a player, anonymous matches, simulation software which involves a visual display, monitoring and control systems that involve a visual display, and the like.

Preferably, the extraction process occurs at a remote server or other computational device, which is different from the computer or computers on which the gaming is being performed. It should be noted that by “server” it is optionally meant a plurality of different servers. Also, the term “computer” may optionally include any game playing device, including dedicated game playing devices. By performing the extraction process at a remote computer or other device, the load on the computer or other device performing the gaming is reduced. It is not intended that the computer or other device performing the gaming is necessarily local to the user (player who is playing the game), although optionally the computer or other device performing the gaming is local to the user. Therefore “remote” refers to the preferred distinction between the computer(s) or other device(s) performing the gaming and the computer(s) or other device(s) performing the extraction process.

Optionally and preferably, the clips may be analyzed, for example to more preferably support later searching of such clips, optionally and most preferably for a clip having one or more features of interest. For example, such features of interest optionally and preferably include but are not limited to a type of scene, a type of action, the presence or absence of a character, the presence or absence of a player or of one or more activities of the player, the presence or absence of an entity (whether animate or inanimate), success or failure of a character or of a player, or of an action by a character or a player, any of the above related to a group of characters or players, any type of special events, and so forth. The term “special event” may optionally refer to any type of event that is predefined as “special” and/or events that are statistically determined to be rare or unusual, according to some type of threshold.

By “online”, it is meant that communication is performed through an electronic and/or optic communication medium, including but not limited to, telephone data communication through the PSTN (public switched telephone network), cellular telephones, IP network, ATM (asynchronous transfer mode) network, frame relay network, MPLS (Multi Protocol Label Switching) network, any type of packet switched network, or the like network, or a combination thereof; data communication through cellular telephones or other wireless or RF (radiofrequency) devices; any type of mobile or static wireless communication; exchanging information through Web pages according to HTTP (HyperText Transfer Protocol) or any other protocol for communication with and through mark-up language documents or any other communication protocol, including but not limited to IP, TCP/IP, UDP and the like; exchanging messages through e-mail (electronic mail), instant messaging services such as ICQ™ for example, and any other type of messaging service or message exchange service; any type of communication using a computer as defined below; as well as any other type of communication which incorporates an electronic and/or optical medium for transmission. The present invention can be implemented both on the internet and the intranet, as well as on any type of computer network. However, it should be noted that the present invention is not limited to on-line games.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and memory storage, and/or the ability to execute one or more instructions may be described as a computer, including but not limited to a PC (personal computer), a server, a minicomputer, a cellular telephone, a smart phone, a PDA (personal data assistant), a pager, TV decoder, VOD (video on demand) recorder, game console or other dedicated gaming device, digital music or other digital media player, ATM (machine for dispensing cash), POS credit card terminal (point of sale), electronic cash register, or ultra mobile personal computer, or a combination thereof. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 shows a schematic block diagram of an exemplary, illustrative non-limiting embodiment of a game program architecture according to the present invention;

FIG. 2 shows an exemplary, illustrative non-limiting embodiment of a gaming system according to some embodiments of the present invention;

FIG. 3 is a flowchart of an exemplary, illustrative method for obtaining the clips and analyzing them;

FIG. 4 shows a schematic block diagram of another exemplary implementation of the system according to some embodiments of the present invention, with an emphasis on the “back end” components; and

FIG. 5 shows an exemplary non-limiting embodiment of an analyzer subsystem according to some embodiments of the present invention.

### DETAILED DESCRIPTION OF PREFERRED EMBODIMENTS

The present invention is of a system and method for a technological platform in which “clips” or short segments of play from a game may be automatically extracted. The short segments of play may optionally be extracted automatically according to one or more predefined criteria. Alternatively, the short segments of play may optionally be extracted from saved game playing data, such that optionally and more preferably, the extraction process may be performed according to one or more criteria that are set before, during or after game play has occurred.

By “clip” or segment of play it is meant a sequence from a game as defined herein. The sequence may optionally be a video sequence, one or more maps, illustrative drawings/animations, a general assessment of play (for example, which players are likely to turn out into a leading gamers, and therefore should be watched carefully), data of statistical nature (which players are likely to be interested in purchasing a product, which ones are more likely to play a certain game), and so forth. If the clip features a video sequence, then the video sequence preferably includes streaming video data and/or a sequence of video frames and/or other suitable video data. Optionally and preferably, the clip also includes audio and/or any other type of media.

The clip is not necessarily a direct replay or reconstruction of the video sequence from the actual game play itself. Rather, the clip may optionally be reconstructed from data obtained during the actual game play. Such an option not only potentially reduces the amount of bandwidth required to submit the data to the remote server or other remote device, as described in greater detail below, but it also enables the reconstruction of the clip to alter the visual representation in some manner, such that the visual representation is different from what was provided during the game play. For example, the clip could optionally and preferably be altered to show the action from a different perspective, whether that of a different character featured in the clip, a different location in the scene, a different POV (point of view) or any other such alteration. Also it is preferably possible to pause, stop, rewind, fast forward and so forth through the clip, as well as to replay the clip.

Preferably, the extraction process occurs at a remote server or other computational device, which is different from the computer on which the gaming is being performed. By performing the extraction process at a remote computer or other device, the load on the computer or other device performing the gaming is at least not significantly increased. The extraction process may optionally feature being provided with data extracted during the game play itself, rather than streaming video of the game play to the remote device, as described above, in order to reduce problems of bandwidth.

Optionally and preferably, the clips may be analyzed, for example to more preferably support later searching of such clips, optionally and most preferably for a clip having one or more features of interest. Preferably, the metadata associated with the clips is analyzed, again for example to more preferably support later searching of such clips, optionally and most preferably for a clip having one or more features of interest. For example, such features of interest optionally and preferably include but are not limited to a type of scene, a type of action, the presence or absence of a character, success or failure of a character or of an action by a character, and so forth.

Searching of the clips is preferably supported by a search engine, which extracts one or more of the above parameter values. Upon submission of a search request to the search engine, the parameter values submitted in the search request may then optionally and preferably be matched to those values of the actual clips. The search engine preferably supports searches by using a special query language that is built specifically for this domain. The search is then preferably performed over the data that will be gathered before the video is produced, such as the meta-data described herein, not on the video itself.

Another optional feature for analysis is ranking or grading the player on the efforts made or the actions performed, for example in order to provide feedback to the player.

Games as defined herein are typically programmed in high-level languages (e.g. C++, JAVA, etc.). Programming efficient components of games from the ground up for each game is neither economical nor necessary; hence developers of games reuse components from one game to another.

The language for constructing requests for selecting one or more segments is described with regard to the PCT application entitled “SELECTION SYSTEM FOR GAMING” by the present inventors and owned in common with the present application, and co-filed on the same day as the present application, and which is hereby incorporated by reference as if fully set forth herein. Without wishing to be limited in any way, the language is preferably a scripting language as described in the co-filed PCT application which can be easily programmed and which is then automatically translated to a query. Upon execution of the query, the desired game play data is extracted and a “movie” of the extracted data is preferably created.

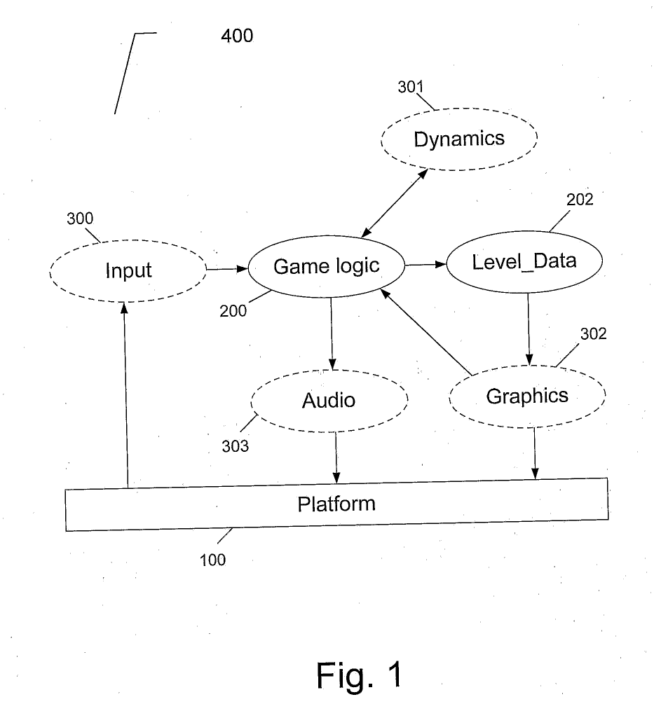

FIG. 1 shows a schematic block diagram of an exemplary, illustrative non-limiting embodiment of game program architecture according to the present invention.

The division to components separates the content components (dashed components: Input 300, Dynamics 301, Graphics 302 and Audio 303) from the game engine components (Game Logic 200, Level Data 202). The content components are changed from game to game, while major parts of the game engine can be easily reused and modified for creating a new game. There are several major engines, which are being used by the vast majority of the games.

Platform 100: comprises the interface of the player and the I/O (Input-Output) devices of the player's machine. Input devices can include a keyboard, a mouse, a joystick, a microphone or other audio input device, a wireless or wired hand-held controller such as the Wii® controller for example, etc. Output devices can be speakers, screen monitor, etc. Platform 100 also includes the application on the player machine (e.g. a PC), which manages the communication with the game server, transmits the player actions during the game, receives data of the game (i.e. graphics, audio, etc.) and renders it.

All of the components of the system as shown in FIG. 1, apart from platform 100, are included in a gaming apparatus 400 as shown.

Input 300: receives inputs from the player and translates it to events on the game according to the game stage/phase. For instance, the left/right keys (arrow keys on the keyboard) in one phase of the game that can be translated to moving events of a character, while in another phase, the same arrow keys can be translated for aiming a weapon or for browsing a menu.

Graphics 302: is the rendering engine. This component is a core component in every game engine. Graphics 302 has the overall responsibility for the translation of the graphical objects/data to the desirable visual images of the present game scene. While rendering engines vary in their approaches to graphics hardware management, it is now common to use the native graphics SDK (Software Development Kit, e.g. OpenGL, DirectX, etc.) of Platform 100 as a buffer between the specific graphics hardware of Platform 100 and Graphics 302 component. Optionally, middleware may also be used. In a 3D environment, Graphics 302, as the rendering engine would load level data and object data as a mathematical representation of 3D vertices in space and forward the relevant information through vertex and index buffers to the native graphics SDK of Platform 100. Graphics 302 also forwards controlling parameters such as camera viewing frustum, usage of anti-aliasing algorithms and other pre-processing to the native graphics SDK of Platform 100. The rendering engine is also capable of higher complexity operations such as light source and light direction, and so forth.

Audio 303: is responsible for handling the game audio including ambient sounds such as waves, birds, music etc., and specific sounds of events such as gunshots, a ball being hit etc. On one hand, Audio 303 serves as an API (Application Program Interface) of the game logic and on the other hand it is connected to the low level drivers of Platform 100. The drivers on Platform 100 take the audio commands from the Audio 303, translate it to sound waves and transfer the sound waves to the sound output of Platform 100. For example, a player may press a mouse button to trigger a shot. Game logic 200 translates the mouse click to release a shot and notifies Audio 303 on a new sound event. Audio 303 finds the relevant sound file for that event and communicates with the drivers of the sound card Platform 100, which in turn plays the sound through the speakers of Platform 100. Audio 303 may also optionally comprise an audio rendering engine which operates similarly to the above described graphic rendering engine.

Game Logic 200: is the creative level in which a game is really defined. While all other components are already relatively standardized industry-wide and can be purchased as 3^{rd} party components, the game logic must be redefined for each game, as the same way where two movies cannot have the same script. Game logic 200 handles the inputs received from Input 300 and decides about the appropriate actions and outputs upon it, while mediating between all the other components and using their API's as necessary. For example, a soccer game, where the player presses one of the buttons of the game controller, i.e., output device on Platform 100. Game logic 200 receives the player's event from Input 300 and analyzes the event according to the context of the current game state. For example, if the player is now in a defensive position, Game logic 200 might understand that the player wishes to tackle the opponent, whereas if he was attacking, the same input would be interpreted as an attempt to kick the ball towards the goal. Once the input is handled, Game logic 200 sends signals to Graphics 302 to transfer the graphics data to the low level SDK on Platform 100. In addition, it would notify other components as necessary (such as raising a “kick ball” sound event to Audio 303).

Game logic 200 may also optionally feature artificial intelligence (AI) both for the operation of the game and also for controlling the actions of one or more characters or entities within the game.

Dynamics 301: Also known as the physics component. This component is responsible for the physical interactions of objects in the game. The demands of such a component vary from one game to the other, but with the standardization of this component and the abundance of 3^{rd} party solutions, there are core functions that repeat themselves among such components. One of the most common tasks performed by a physics component is the seeking collision between objects, or collision detection as it is usually referred to. This functionality revolves around the check of whether one physically simulated object in the game has intersected another. In such a case, Dynamics 301 notifies Game logic 200 about the event with the necessary details for action (e.g. involved objects, angle of hit, etc.). There are other functions to the physics component, such as applying different types of forces on objects (e.g. gravity, drag, recoil etc.).

Level Data 202: Games employ a mechanism in which the game data is strictly separated from the code layer. The same game code in Games logic 200 can usually load many different levels without awareness of the difference in content. Level Data 202 comprises data pertaining to the 3D objects within the environment of the game levels, their respective textures and other elements necessary for displaying the level. However, the level data contains much more than just that, and would usually contain “hints”, or other forms of metadata used by various components in the game in order for it to operate completely. For example, the level data would contain the necessary visual data to describe a certain room, but it would also contain metadata hinting that a certain volume in the region triggers a specific event in the game, as well as a specific sound.

Distinction of the game engine components from the content component, as described above, allows the system according to some embodiments of the present invention, described in greater detail below, to capture the desired data objects of the game while the objects are transferred among the various components of the game program.

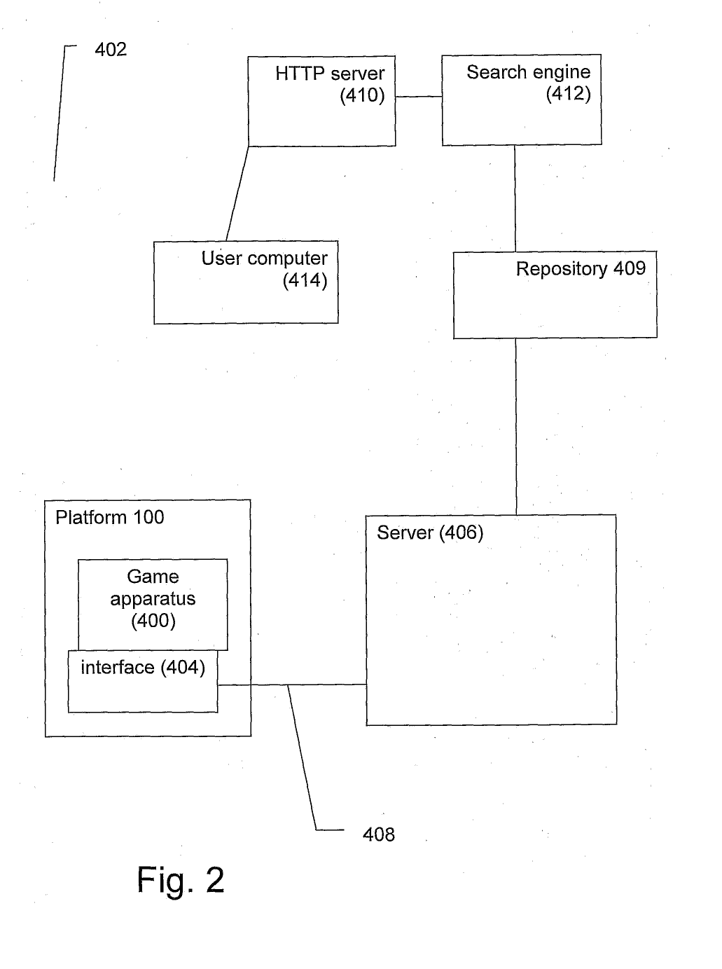

At online games, the game program is installed at a server and/or at platform 100; one or both locations feature the components of the game engine and the content as well. The player (client) side application comprises Platform 100 as described in FIG. 1. The system of the invention captures the data objects on the communication events between the player and the server. This embodiment is described in greater detail below with regard to FIG. 2.

One of the core components of the system of the invention is the Generic Games Representation Language (GGRL), which is capable of translating data, generated by any game engine, into a special generic representation language. After the original game data is translated to the GGRL, the generic data is analyzed. Every game has its own language, which comprises various data types that can be categorized into several pre-defined lexical categories, such as background elements, actions of movements, articles, etc. During the translation process, each data type is being mapped into one or more data elements in the GGRL. The GGRL elements are accompanied with indexing, symbolizing a specific element, the dominance/strength of an element or the functionality of an object.

The GGRL comprises data elements as follows:

Background—background view, elements rendered by the game engine to foliage, landscape, etc.

Objects—the main elements in the game, in terms of importance, symbolizes other players, monsters, etc'. Objects can sustain positive of negative effects, and usually possess the ability to manipulate the gaming world.

AutoObjects—There are game engines where the raw data distinguishes between human (player) controlled objects and automatic controlled objects. The second type will be translated to AutoObjects.

Subjects—used for objects which do not have any effect on the players, but can be manipulated by them (e.g. doors, chairs, articles that can be picked or moved, etc.).

PosActuator—object which have a positive influence over a player (e.g. treasure chests, medical kits, bonus elements, etc).

NegActuator—object which have a negative influence over a player (e.g. flying bullets, poison, etc).

PosAction—an action on an object, which bears a positive effect (usually involving a positive actuator), for example—a player picking a medical kit and getting his health enhanced.

NegAction—an action on an object, which bears a negative effect (usually involving a negative actuator), for example—a player getting hit by a bullet.

Event—an event that occurs in a game that is not otherwise covered by a PosAction or a NegAction.

GameSpecific—a unique object/action/actuator of a specific game. Each game may have its own GameSpecific objects added to the GGRL. Although this definition is game specific, it becomes an integral part of the generic game-independent infrastructure, and thus does not require any special treatment on the GGRL.

Strings of sequences of GGRL elements (and relationships between these elements) are formed in order to describe actions of the game. For example, a knife lying on the ground may be translated to the sequence {Subject(2), NegActuator(7), GameSpecific(2)}. The first element represents the knife being a subject that can be picked up or moved; the second element represents the knife's ability to inflict wounds to other characters; the third element represents the knife being a stabbing weapon (assuming that a category of the various stabbing weapons of the game was defined). In this example, a single data object of a game, i.e. knife, is translated into three elements.

During the operation of the game's engine, it produces streams of meta-data, i.e. game data objects, which are captured by the system of the invention before the client application renders the game data. The system of the invention optionally also captures the data which is sent from the player to the game engine (optionally on the server). Then the data is translated into the GGRL. The GGRL enables the system of the invention to perform analyses and manipulations on the generic data.

Any application, based on GGRL, can be easily integrated into any game with significant reduced resources (i.e. time, professional staff, etc.) comparing to the resources which the game companies need to invest in order to obtain similar applications. Integrating application, based on the GGRL to any game, consumes about ten work days of one programmer, while practical estimations shows that developing the same application for a specific game (without using the GGRL), game companies need for about three to five programmers' work for about two years.

FIG. 2 shows gaming apparatus 400 and platform 100 from FIG. 1, as part of an overall system 402. Gaming apparatus 400 is able to at least send, and preferably also receive data, through an interface 404. As shown, platform 100 is in communication with a server 406 through a network 408, which is preferably a computer network such as the Internet for example. Gaming apparatus 400 is therefore preferably also able to send data to server 406 through network 408. The data is preferably in the form of GGRL game data objects and/or language commands and/or parameters and/or other data, as described above. The data is preferably transmitted during game play, ie during interactions of the user (not shown) with gaming apparatus 400, to play the game.

The game data objects are then preferably analyzed by server 406 to construct one or more clips, as described in greater detail below. Server 406 also preferably analyzes the clips according to one or more parameters, in order to characterize them, also as described in greater detail below. Briefly, the characterization of the clips provides metadata, which is then preferably associated with the corresponding clip in a clip package. The clips and their corresponding characterization, preferably as clip packages, are more preferably stored in a repository 409.

The clips may then be searched, for example through a web based interface. As shown, system 402 preferably features a HTTP server 410 for supporting such a web based interface to a user computer 414. In addition, system 402 preferably features a search engine 412 for enabling a user operating user computer 414 to search through the clips. HTTP server 410 is in communication with search engine 412, in order for the search request of the user to be passed to search engine 412. Search engine 412 is preferably in communication with repository 409, in order to be able to search through the clips and their corresponding characterization, to locate and return one or more clips of interest to the user. The clips may optionally be played in the Flash format to the user through user computer 414, in which case the clips are preferably stored in the FLV (flash video) format, or alternatively any other standard video format as is known in the art, or any proprietary format.

Server 406 and repository 409 may optionally be considered to comprise the “back end” of system 402, while HTTP server 410 and search engine 412 may optionally be considered to provide the “front end” of system 402. Optionally, a plurality of such “back end” components may be included in system 402 (not shown). Furthermore, to assist in delivery of the clips themselves to user computer 414, optionally a content delivery network (CDN) may be used (not shown). Also optionally, the content of the clips and their metadata, or clip packages, may optionally be syndicated to other websites and/or other servers (not shown).

It should be noted that although gaming apparatus 400 is shown as being installed at platform 100, optionally gaming apparatus 400 may be installed at server 406 instead and/or a different server (not shown).

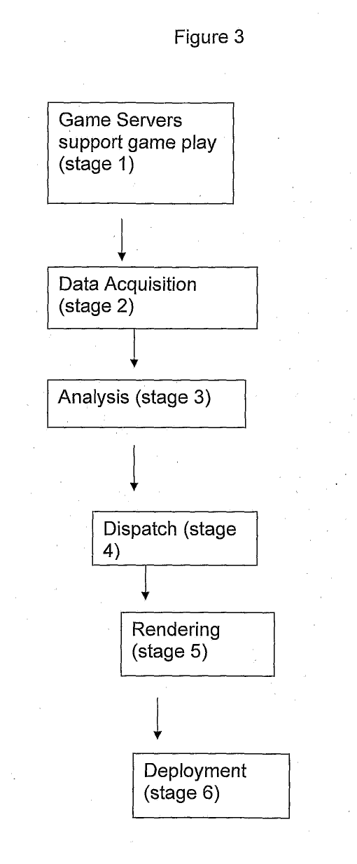

FIG. 3 is a flowchart of an exemplary, illustrative method for obtaining the clips and analyzing them. As shown in stage 1, the game server supports game play with the user. The game server may optionally be located at the gaming device of the player, whether as a computer or dedicated device (the platform of FIGS. 1 and 2) or alternatively may located at a separate server, with which the user computer or device communicates, for example through a network as shown in FIG. 2.

In stage 2, game data is acquired, optionally through a specialized interface, from the game servers. For example, interface may optionally be implemented as a plug-in or agent, or mod, whether at the game server or in “listening mode” at some location external to the game server, and/or as a driver on the game client or server. This interface is preferably able to gain access to all game information that the game provides by default. Some games provide a full game play file to allow visual replays and reconstruction of scenes that occurred during game play. Files like this are important for enabling rendering of video sequences after the game play has ended. In addition there are identifiers (game identifiers, players' identifiers etc) that need to be stored for future reference.

The interface may also optionally and preferably be able to gain access to the live action during game play. More information may be gathered by tapping into the game via a plugin that has direct communication with the game in real time. Graphic coordinates, scoring and other game events may be stored to be used for later analysis.

Furthermore, in some embodiments, the interface may optionally be used to send a message or other information to the game itself, for example to inform a player that his or her clip will be available on the website at a later time and/or to advertise the existence and/or features of the website.

In any case, the acquired data is preferably returned to the server or other remote device of the “back end”, as shown in FIG. 2, for analysis. The data may optionally be returned in a streamed format, which has a number of advantages. For example (and without) limitation, streaming permits real time analysis, as described with regard to stage 3 below. It also enables actual “chat” with the players, including live responses. Alternatively, the data may optionally be returned in a batch or “off line” format, or a combination thereof.

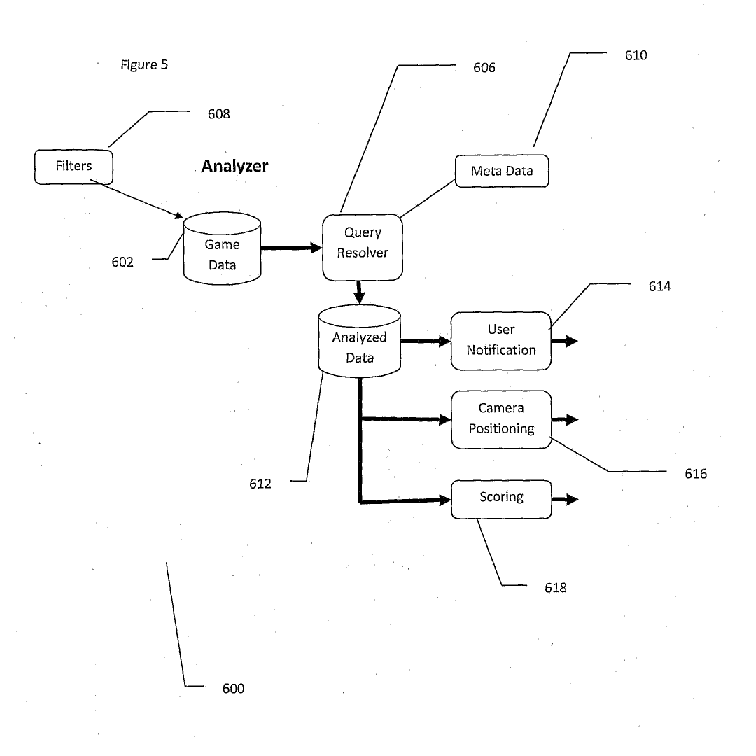

The game data is then analyzed in stage 3. As described above, analysis may optionally be performed in “real time” as streamed data is received; alternatively, analysis may optionally be performed once a package of data has been received. The data is then preferably analyzed to find ‘interesting’ areas which will then be candidates for conversion into video clips. Each area of interest will generate a set of scores which will be combined at the end to prioritize for rendering. The determination of “interesting” and indeed the actual method of analysis are both preferably game type (genre) and/or game dependent. However, the analysis is preferably performed so that the game dependent features are rendered onto a common template or format, in order for the clip packages to be created. A more detailed description is provided below with regard to FIG. 5.

Also as described with regard to FIG. 5, one or more functions are preferably applied to determine which segments of data are most of interest or importance, according to a scoring mechanism also described below.

After application of the function or functions, a list of time segments and a score that signifies the importance of the segments are obtained. Optionally, additionally or alternatively, data is obtained which relates to one or more parameters for searching. This data is now passed on to the next stage (stage 4) that decides in what order, if at all, the segments are to be rendered.

In addition, for every time segment, the Analysis stage needs to also extract metadata, also as described with regard to FIG. 5. Specifically, metadata includes the player(s) involved, game ID, game score or other attributes etc. These will be created as a data file that will hold all these parameters as well as the score(s), and other operational data. This data file is then passed to the next stage (stage 4) as the output of the analysis.

Dispatch is then performed in stage 4, in which the segments are prioritized for rendering. Optionally, not all segments are rendered, such that only those segments selected in this stage are rendered. Without wishing to be limited in any way, optionally one or more features of the segments are used to determine whether they are to be passed for rendering, including but not limited to constraints on the rendering system, difficulty or time required for rendering a particular game, importance of a particular game and/or game instance (tournament vs. a regular game) and/or player, whether the segment is likely to require more time to render, desired timing for completion of rendering, likelihood to be watched or used, and so forth.

For each segment, preferably a feature vector of all these features is created, which more preferably includes the segment score from the Analysis stage. This vector is then preferably multiplied by a normalized weights vector that defines the importance of each feature to obtain a final Rendering Priority score.

The Dispatcher holds at least one sorted Rendering Queue which continuously receives new segments for sorting. The segments are sent in decreasing priority into the rendering stage. New items enter this queue all the time which means that lower priority items get pushed down. Items that are below some score threshold or that have been too long in the queue may optionally be discarded. Also optionally, segments may be discarded if they are complete or partial duplicates and/or if the entire game has been previously rendered as an incoming stream.

If the rendering stage has different rendering platforms, and assuming that games need a particular platform to render, the Dispatcher may optionally provide a separate queue for each rendering platform.

To determine whether the rendering queue is operating efficiently, optionally the priority value at the top of the queue (or the average of the first few) is monitored. This number correlates to the system load. If the queue top priority is high it means that the system is not rendering clips fast enough. This usually shows there is not enough rendering capacity. If the queue top priority is low it means that either there is a lot more rendering capacity then needed, or that there are not enough games pushing data in.

Tracking this number over time will give a good view of the system state. However, over time there may be some sampling issues with this number. It is best to run a low pass filter on the data as there may be spikes when a high priority item is momentarily sampled at the top of the queue even though the rest of the queue may be empty. It may be better to use the average of the top n items or the actual priority of the n'th item to avoid these spikes. The sampling rate of this number needs to be at least twice as high as the rendering stage throughput.

The clips are rendered in the desired format in stage 5. Rendering is preferably performed according to a video template which directs how the various components are to be combined. Once selected and provided as described above and also optionally from other aspects of the description herein, the technical combination of two or more movie components, such as for example adding a “voice over” to the movie, may optionally be performed as is known in the art. Rendering is preferably performed by a plurality of machines, such that multiple rendering queues may optionally and preferably be distributed across the plurality of machines. There are two main configurations for rendering with multiple machines. The first is a Serial Configuration: A segment of a game instance that enters rendering is assigned a specific machine. All the work for the segment is done by that particular machine. The second is a Parallel

Configuration: A segment that enters may be split to use as many machines needed/available. The video frames are processed on multiple machines and are combined at the end into a single video clip.

These methods trade simplicity for efficiency. The Serial configuration is much easier to implement at the expense of having hardware possibly idle while there is work to be done. If rendering time is very long this may be painful. The Parallel configuration makes single clip throughput higher but is much more complicated to implement.

It should be noted that if the load on the system is very high, and all rendering machines are constantly utilized, there is no difference in the overall throughput between these methods (actually the Serial has a slight advantage as there is no combination step at the end of the rendering).

A related issue regards the amount of control available over the rendering process. Different games may have different constraints on how they render a segment. In particular, this refers to how to determine the segment start time. One method uses Random access—the segment start time may be accessed freely anywhere in the timeline and in roughly the same amount of time as any other frame. Another optional method uses Serial access—Start times at the beginning of the timeline are faster than the ones at later times. Yet another optionally method does not use any access; rather rendering always starts at the beginning of the timeline, and possibly ends only at the end. After the rendering is complete, the segment is created by editing the resulting video.

The selection of the method may be game dependant. It may also be configuration dependant. Random access makes implementing parallel configuration much simpler. No access makes it very complicated. As usual each of the above methods has pros and cons. For a single arbitrary positioned short clip, Random access is the clear winner. However, if several clips need to be rendered from the same game, then the other method may be more useful. If a game has a large chunk of its timeline covered by some segment, No access may actually be faster. It is easier to optimize situations in which segments share frames.

An optimal method of managing the access is to be able to do both pre and post editing, while caching any partial results already rendered. If Random access is available render only the frames needed for a segment, reusing frames that were previously rendered. At the end edit out the exact segment needed.

If only No access is available, after the initial render, all the segments can be edited out of the full rendering.

Regardless of the method selected, the end result is a video clip that is optionally and preferably in FLV format or any other video format as described herein. The clip is packaged together with accompanying metadata created in previous stages and stored in temporary storage, ready to be deployed. After that, the segment may be marked as processed and removed from the Dispatcher queue. Optionally however at least some data, such as the metadata, may be stored for further analysis of other segments for example.

In stage 6, the clips and their metadata are provided in clip packages to the repository and/or other servers which are to provide them to end users, through deployment.

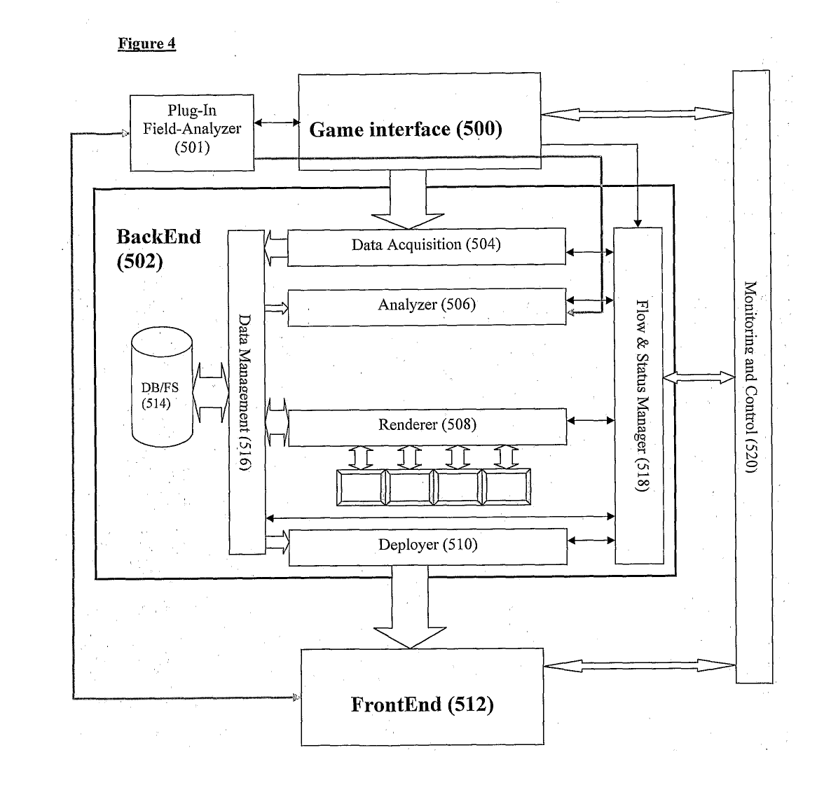

FIG. 4 shows a schematic block diagram of another exemplary implementation of the system according to some embodiments of the present invention, with an emphasis on the “back end” components. These components relate to features described in greater detail with regard to FIG. 3. As shown, a game interface 500 is in communication with a back end 502. Back end 502 preferably includes a data acquisition module 504 for acquiring data from game interface 500. The data is then passed to an analyzer 506 for analysis, for example to determine whether the segment or clip represented by the data is of interest, and also one or more characteristics for determining the metadata which is to be associated with the clip.

However, optionally, game interface 500 is in communication with a field analyzer 501, which may optionally and preferably function as a preliminary filtering or screening mechanism regarding data to be sent to back end 502 and which may optionally also alter the capturing process. Field analyzer 501 may also optionally perform an initial low granularity prioritization of the clips. Field analyzer 501 may optionally also use metadata as part of the filtering and/or capturing and/or prioritization processes. Field analyzer 501 preferably also communicates with analyzer 506, for example by sending data directly to analyzer 506 and/or by receiving one or more filtering commands directly from analyzer 506.

Field analyzer 501 is optionally and preferably implemented by the server operating game interface 500 (not shown). If the server operating game interface 500 is not able to provide sufficient processing power, then optionally field analyzer 501 is not implemented.

If the clip is determined to be of interest, then it is preferably rendered by a renderer 508 as previously described, and then deployed by a deployer 510 to a front end 512, which may optionally be configured to permit access by an end user, for example through a web server (not shown).

To support the functions of back end 502, optionally and preferably data flow into and out from a database 514 is supported by a data management module 516. The operation of data management module 516 is preferably transparent to the remaining components of back end 502.

Also optionally, a flow and status manager 518 preferably monitors the flow of data between the components of back end 502, as well as determining the status of various processes. In turn, a monitoring and control process 520 preferably communicates with flow and status manager 518 in order to provide overall management of the operations of back end 502, and also monitoring to ensure proper functioning of the components thereof.

FIG. 5 relates to a description of an exemplary analyzer subsystem 600 according to some embodiments of the present invention, which may optionally be implemented with regard to any of the systems and methods described herein. Analyzer subsystem 600 presupposes that the determination of “important” or “interesting” features for scoring of the segments of game play data is performed according to one or more queries. The exact structure of such queries is not limiting or important for the description of the analyzer subsystem 600, but may for example optionally be constructed according to the visual language described with regard to the previously described PCT application entitled “SELECTION SYSTEM FOR GAMING”. The queries preferably include one or more game dependent parameters as previously described.

Specifically, optionally and preferably, in order to place all the game dependant parameters into a consistent game-neutral or general framework, an abstraction level is created that will allow to fill the gap between dependent and common parameters. An exemplary model of such a framework is provided below for the purposes of illustration only, without any intention of being limiting in any way.

In this model, for every game there will be a set of features that will be deemed ‘interesting’ for that game. In a shoot-them-up game a feature may be a crazy shot, a fast move, very high accuracy, horrible fall/blooper etc. Features will be scored a number between 0 and 1, where 1 is the highest score, for example. The set of all features of a particular game are optionally and preferably ordered in a feature vector. The length of the vector as well as what every feature in it represents may be different between games. No correlation is assumed.

The features that the analysis stage is concerned with are all game related. There are other features that may influence the selection of a segment that are independent of the game (for example the identity of the player, system load etc) and these will be factored in at the dispatching stage.

As interesting events happen at different points in time of a game, every feature may have zero or more timestamps associated with it for a particular game instance. This means that the data set is a 3D set of points where the axes are feature, time and score (or the feature vector changing through time).

When game data arrives, the analysis will look for specific events or patterns that correlate to features and score accordingly. Preferably a trigger is used to quickly review and select data as being useful or interesting. For example, if the data needs to include a particular state of a character, with regard to health, an action performed or any other parameter, then only that part of the data is preferably examined first. If the data does not include the desired character state, then the rest of the data is preferably not examined. Various methods may optionally be used to analyze such features. For example, optionally specific code may be provided to check for a specific feature throughout the game (change in score, arrangement of players as game characters or participants etc) and marking the time that event happened.

Turning now to FIG. 5, analysis subsystem 600 preferably includes game play data 602 that is received through one or more filters 608 as previously described. The game play data 602 is then preferably analyzed by a query resolver 606.

Query resolver 606 preferably applies one or more queries to the game play data in order to analyze this data. Queries are elements which describe properties of a game or part of a game. It can describe an event in the game, certain behavior of one or more players, interaction between players, interaction of players with the environment, or any combination or sequence of the above.

Query resolver 606 preferably handles multiple queries at the same time. Moreover, query resolver 606 can preferably find and match multiple instances of the same query (for example, if a certain query can be applied to any of the players, more than one instance can be matched simultaneously) and/or of sub-queries that may optionally be applied to or are otherwise part of a plurality of queries. On the other hand, there are queries that can be matched only once during a certain period of time (i.e. “Game round”).

There are optionally (and without limitation) two sources of queries for query resolver 606. Some queries are pre-defined and hard-coded in the source code itself, while other queries are dynamically defined using the visual tool or written directly using the query language.

For performance reasons, as described above, analyzer subsystem 600 preferably does not search for all queries all the time. A query is checked only if its trigger has been met. Only once a trigger event has happened, query resolver 606 instantiates the relevant query or queries.

A trigger can optionally be related to any of the components of the query, but is usually chosen to be either the first event in the query sequence (for the ability to match the query in real time), or the event with the lowest probability of happening. This significantly reduces the number of instances that are created but not matched.

The trigger is preferably an item that is easily matched without further analysis or computation (i.e. an “atomic” event). For queries which are created dynamically, the decision of which part of the query to use as trigger is taken by analyzer subsystem 600 according to probability tables created in advance or by using learning algorithms and statistical tools.

Once a query has been triggered query resolver creates an instance of the query. This instance exists as long as the different parts of the query are matched and as long as the query can still be fully matched (for example, if a query requires a sequence of 2 events happening one after the other with less than 10 seconds interval, and more than 10 seconds have passed since the first was matched, but the second didn't happen, the query is deleted). However, optionally such data is stored for a period of time; preferably at least metadata is stored for a period of time.

Once the list of queries for a game round has been set, query resolver 606 checks what information is required from the game for detection of the triggers of the various queries. This reduces the amount of information the system collects from the game, and thus reduces resources consumption. This decision also involves the usage of “meta-data”—data about the specific game round or players, as described in greater detail below. In certain cases more data will be collected for future use, or according to a special request by one of the participants or any other interested party.

Once a trigger has been detected, analyzer 600 preferably then requires that all the information from the game which is relevant for query that has been instantiated. Although this requires more data to be kept, it still removes the need to collect all the available data.

After the activation of additional data collection (if required), analyzer 600 will follow the satisfaction of the query by optionally using a state machine, through query resolver 606. The state machine uses the projection of all the game data collected to a specific feature space to check whether each instantiated query is still being satisfied, or if it can no longer be satisfied at all (at which case the instance is dismissed).

Of special note are cases in which the definition of a query has multiple paths (i.e. one event took place OR another event). Analyzer subsystem 600 must not only check for satisfaction of the query, but also supply exact details of what path was the one that was matched. Preferably, analyzer subsystem 600 also supplies all the data regarding the satisfaction of the query. This information might include exact timing, participating players, location and other game specific details.

This data can later used by the automatic video editing tools for rendering and creation of movies, calculation of scores and any of various applications.

Optionally and preferably, there are two instances of analyzer subsystem 600 running. One is the “field analyzer”, running on a game server and performs analysis in real-time. While some of the applications require real-time analysis (like live coaching and user notifications), the field analyzer uses the game server resources, so it can change its capacity of work dynamically, based on current resources consumption. The “Data Analyzer” runs on dedicated machines and thus can perform all the analysis, including heavy duty calculations, retroactive analysis, statistical calculations over several game rounds, etc.

In addition to data analysis, query resolver 606 preferably also obtains metadata 610. Specifically, metadata 610 includes the player(s) involved, game ID, game score or other attributes etc. These will be created as a data file that will hold all these parameters as well as the score(s), and other operational data.

One set of parameters created includes the video directing orders: Camera coordinates, Points of View (POV) and other parameters that affect the way the video is shot. These need to be calculated via graphical analysis, or may be exportable from some games. For all purposes, two segments with different directing orders are different segments even though their time segments may overlap or even be identical. Different directions result in different renderings. This holds true also for any other parameters that affect the way things are rendered (quality, window size etc).

Query resolver 606 preferably also passes the analyzed data 612 to a user notification module 614, a camera position module 616 and a scoring module 618.

Scoring module 618 scores the game play data segments. The score given in this part of the analysis is relative to the feature itself. This means that if a feature is a Boolean feature (i.e. either occurred or not), a score of 1 is provided if the feature occurred and 0 if not. Other features may optionally be scored according to an internal scale that makes 1 a “wow” for that feature regardless of how important that feature is overall.

The result is a set of scored events and the time segment at which they occurred.

Next, preferably one or more time segments are selected as being the most interesting to render. Some time segments may have multiple features scoring high in them. Some features may be more important than others. Some features may be significant only if other features are high in tandem and/or according to popularity, player request, payment and so forth

To get a final score for each segment the scores of the features in it are preferably combined to provide a single score between 0 and 1 for each segment. This defines a function that takes the feature scores and results in a single value. Such a function may optionally be implemented in a number of ways. For example a linear function may optionally be employed with a normalized vector of weights between 0 and 1 and taking the dot product with the segment vectors. Also a matrix function may optionally be used, by multiplying by a matrix that defines correlations and connections between the features and then a dot product. Also non-linear or logic functions may optionally be used. The method selected may optionally and preferably be game dependant.

Optionally, additionally or alternatively, a score for all features is given for every time sample of one second or less than one second or more than one second, for example. Then a sliding window or any other mathematical (convolution, feature extraction) filter is employed to find a segment of a particular length that has a consistently high score, peak or some other significant result.

According to some embodiments, the user is able to semi-manually select components of the game play data for manually constructing a film clip, in which the user selects from a predefined list of features which are to be extracted and placed into the clip, from a predefined portion of game play data as selected by the user.

Although embodiments of the invention have been described by way of illustration, it will be understood that the invention may be carried out with many variations, modifications, and adaptations, without departing from its spirit or exceeding the scope of the claims.

1. A method for providing at least one clip of a game, comprising extracting a segment from the game play data, obtained from playing the game, wherein at least a portion of the game play and/or at least one game action occurs electronically; analyzing said segment to determine metadata, wherein said metadata comprises one or more of player(s) involved, non-player character(s) involved, game ID, game score, and one or more actions performed in said segment and wherein said analyzing said segment further comprises selecting one or more features of interest in the game play; determining whether to package said segment according to said metadata; and packaging said segment according to said metadata to form the clip; wherein the game comprises a game played through a computer or any type of game playing device.

2. (canceled)

3. (canceled)

4. (canceled)

5. (canceled)

6. The method of claim 1, wherein said one or more features of interest include one or more of a type of scene, a type of action, the presence or absence of a character, the presence or absence of a player or of one or more activities of the player, the presence or absence of an entity (whether animate or inanimate), success or failure of a character or of a player, or of an action by a character or a player, any feature related to a group of characters or players, a statistically infrequent event or a predefined event.

7. The method of claim 6, wherein said segment comprises one or more of a video sequence, one or more maps, illustrative drawings/animations, a general assessment of play, or data of statistical nature.

8. The method of claim 7, wherein the clip is a direct replay of the game play data.

9. The method of claim 7, wherein the clip is reconstructed from the game play data.

10. The method of claim 1, wherein said analyzing said segment further comprises translating the game play data to a generic representation language; and
analyzing said translated data.

11. The method of claim 10, wherein said generic representation language comprises a plurality of elements and wherein an action in said segment is described according to a sequence of elements.

12. The method of claim 11, wherein said analyzing comprises analyzing a plurality of elements to determine one or more game data components for said generic representation language and one or more relationships between said elements.

13. The method of claim 1, further comprising packaging the clip with said metadata in a clip package.

14. The method of claim 1, wherein said extracting and said analyzing are performed by a computer or other device remote to a game platform or server providing the game.

15. The method of claim 14, wherein said extracting and/or said analyzing are performed after the game is finished.

16. The method of claim 15, further comprising playing the clip to an end user, wherein said end user searches for and/or selects the clip according to said at least one interesting event.

17. (canceled)

18. (canceled)

19. The method of claim 1, wherein said extracting said segment further comprises listening to data from the game; and extracting data according to said listening.

20. The method of claim 19, wherein said listening occurs in real time during play of the game.

21. The method of claim 20, further comprising sending a message to said end user to indicate that said clip is prepared.

22. (canceled)

23. The method of claim 1, wherein said selecting said one or more features of interest further comprises rendering one or more game dependent features onto a common template, wherein said common template comprises a feature vector and wherein data is extracted according to said feature vector.

24. (canceled)

25. The method of claim 1, further comprising determining video directing orders for characterizing said segment for determining said metadata, wherein the clip is created for the end user by rendering according to said video directing orders.

26. (canceled)

27. (canceled)

28. The method of claim 1, wherein the game is selected from the group consisting of portable device, computer games, on-line games, multi-player on-line games, persistent on-line or other computer games, games featuring short matches, single player games, automatic player games or games featuring at least one “bot” as a player, anonymous matches, simulation software which involves a visual display, and monitoring and control systems that involve a visual display.

29. A system for providing at least one clip of a game from game play, comprising an interface to the game for retrieving game play data, an analyzer for analyzing said game play data; a renderer for rendering the segment to form a clip; and a search engine for searching through a plurality of clips according to a request by a user.

30. (canceled)
